(19) United States
(12) Patent Application Publication
(10) Pub. No.: US 2007/0253607 A1
(43) Pub. Date: Nov. 1, 2007

(54) IMAGE READING APPARATUS FOR FEATURE IMAGE OF LIVE BODY

(75) Inventor: TERUYUKI HIGUCHI, TOKYO (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 11/741,645

(22) Filed: Apr. 27, 2007

(30) Foreign Application Priority Data
Apr. 28, 2006 (JP) JP2006-124712

(51) Int. Cl. G06K 9/00

(52) U.S. Cl. 382/124

(57) ABSTRACT

An image reading apparatus includes first and second light sources configured to emit first and second lights into a detection target, respectively, a 2-dimensional image sensor and a processing unit. The 2-dimensional image sensor has light receiving elements arranged in a matrix, and picks up a light emitted from the detection target through the emission of the first light from the first light source to generate a first image indicating a first pattern corresponding to an internal structure of the detection target, and picks up a light emitted from the detection target through the emission of the second light from the second light source to generate a second image indicating a second pattern corresponding to a surface pattern of the detection target. The processing unit drives the first and second light sources while switching the first and second light sources, and performs a predetermined process on the first and second images.

### CROSS REFERENCE

This application relates to the U.S. patent application Ser. No. ______ claiming the priority based on Japanese Patent Application No. 2006-124711 by Teruyuki HIGUCHI and titled “IMAGE READING APPARATUS FOR FEATURE IMAGE OF LIVE BODY” and the PCT application No. PCT/JP2005/020905 designating U.S.A. The disclosures of these applications are incorporated herein by reference.

### BACKGROUND OF THE INVENTION

1. Field of the Invention

The present invention relates to an image reading apparatus, and more particularly relates to an apparatus for reading an image indicating features of a living body such as a fingerprint of a finger and another skin pattern, in order to authenticate a person.

2. Description of Related Art

Conventionally, as an image reading apparatus for authenticating a person by using a finger, an apparatus is known for reading a fingerprint that is a pattern of a skin of a fingertip. Various types of reading apparatus that uses an absolute value or a change value of a physical value such as light, electric field, pressure, capacitance and temperature, has been developed.

A method that uses a total reflection critical angle in a fiber optic plate (as disclosed in Japanese Patent No, 3045629: first conventional example) or a prism (as disclosed in U.S. Pat. No. 6,381,347: second conventional example) is widely used as a fingerprint input apparatus. FIG. 22 shows a conventional example that uses the total reflection critical angle of the prism. With reference to FIG. 17, a lens 106 and a 2-dimensional image sensor 107 are arranged in a direction perpendicular to a prism plane 109. A skin 104 of a finger is illustrated by enlarging the pattern of the skin, When a light 101 is inputted from an air portion having the refractive index of 1.0 where the skin is not in contact with the prism 105 in to the prism 105 having the refractive index of 1.4, the light has greatly refraction and is totally reflected on the prism plane 109, so that the light does not arrive at the 2-dimensional image sensor 107. However, a light 102 inputted into the prism 105 at a portion where the skin is in contact with the prism 105 never reaches the total reflection angle on the prism plane 109 because the refractive index of fats and oils or water on the skin or skin surface is near to that of prism glass so that a refraction angle on the prism plane 108 becomes small. Thus, the finger pattern is imaged on the 2-dimensional image sensor 107 by the lens 106. Thus, the pattern of the skin such as a fingerprint can be detected as a shadow pattern based on whether or not the concave and convex portions of the finger are brought into contact with the prism.

A conventional technique is proposed in which the optical system such as the prism and the lens is removed, although the 2-dimensional image sensor is used, in order to attain the miniaturization of an apparatus, and a finger is brought into contact with the 2-dimensional image sensor to detect a fingerprint image, as disclosed in Japanese Laid Open Patent Application (JP-P 2001-92951A: third conventional example). This conventional technique will be described below with reference to FIGS. 23A and 23B. The image reading apparatus shown in FIGS. 18A and 18B is provided with a 2-dimensional image sensor 2004 in which a plurality of photo sensors 2001 such as a double-gate type transistors are arranged in a matrix on a glass substrate 2002, and a insulating protection film 2003 having an optically transmissible property is coated on the entire surface; a transparent conductive film 2005 formed to have a predetermined pattern on the surface of the 2-dimensional image sensor 2004; and a planar light source 2007 which is placed on the rear of the 2-dimensional image sensor 2004 and emits a uniform light to the finger in contact with the top plane of the 2-dimensional image sensor 2004. Here, the transparent conductive film 2005 is composed of a pair of conductive patterns 2005a and 2005b, and at least one of them is grounded. Also, both of the conductive patterns 2005a and 2005b are formed only on the mutual gap between the photo sensors 2001, in order to avoid the region immediately over the photo sensor 2001. The 2-dimensional image reading apparatus as configured above is operated as follows.

When a finger is placed to be in contact with a pair of conductive patterns 2005a and 2005b, the static electricity charged on the finger is discharged through any one of the conductive patterns 2005a and 2005b to the ground. Then, the operation for reading the fingerprint is started. That is, light is inputted to the finger through the 2-dimensional image sensor 2004 from the planar light source 2007, and is propagated while being scattered and reflected on the skin cortex of the finger. Then, a portion of the propagated light is inputted as excitation light into a photo sensor 2001 opposite to the convex (ridge) section of the fingerprint where there is no air layer whose refractive index is low on the boundary between the insulating protection film 2003 and the skin cortex of the finger. On the other hand, the other portion of the light is inputted into the photo sensor 2001 opposite to the concave (valley) section of the fingerprint where the air layer exists on the boundary between the insulating protection film 2003 and the skin cortex is suppressed. As a result, a pattern image is obtained in which the convex portion of the finger pattern serves as a bright region, and the concave portion serves as a dark region. In this way, in the image reading apparatus of FIGS. 23A and 23B, while the finger is brought into contact with the top plane of the 2-dimensional image sensor 2004, the fingerprint image is read. Thus, the transparent conductive film 2005 is made thin not to disturb the contact between the finger and the 2-dimensional image sensor 2004.

Similarly, the skin is brought into contact, so that a fingerprint image is obtained. However, in order to attain further miniaturization, other techniques re proposed in Japanese Laid Open Patent Applications (JP-A-Heisei 10-91769 and JP-P2001-155137A: fourth and fifth conventional examples). In such techniques, a quasi one-dimensional sensor of a pressure or temperature or capacitance type is used, and partial images of the fingerprint of a finger that is obtained by moving the finger in contact with the quasi one-dimensional sensor are linked to reconfigure the fingerprint image. In particular, methods that use the capacitance and the temperature are already available in a market. These methods contribute to the miniaturization and lower price of the apparatus.

Under such a situation, a non-contact fingerprint detecting apparatus is proposed as disclosed in Japanese Laid Open Patent Application (JP-P2003-85538A; a sixth conventional example). This conventional technique uses a phenomenon that when light is inputted into a finger, scattered inside the finger and emitted from the finger again, the light reflects the inner structure of the skin, so that the concave of the fingerprint serves as a bright region and the convex serves as the dark region. Thus, the dense/light image having the same shape as the fingerprint is obtained. According to this non-contact method, even in the finger whose skin is stripped due to dermatitis so that it is hard to read the fingerprint because contact of a skin separation portion is difficult in a method where the foregoing contact is assumed, the fingerprint image can be obtained if a portion of a structure inside the skin deriving a skin pattern is reserved, Also, in case of non-contact, it is difficult to receive the influence of the state change on the skin surface, such as a wet or dry state.

Also, a fingerprint input apparatus was proposed by the inventors of the present invention as disclosed in Japanese Patent No. 3150126 (a seventh conventional example). In this conventional apparatus, a fingerprint image is imaged by detecting the scattered emission light from the finger by a 2-dimensional image sensor located closely to the finger through a transparent protection cover made of glass. Thus, a concave portion of the fingerprint serves as a dark region and a convex serves as a bright region. This is hard to receive the influence of the external environment such as a wet or dry state of the finger, and the external disturbance light as compared with a sensor that uses pressure, temperature, capacitance and a total reflection critical angle. Also, as described in Japanese Laid open Patent Application (JP-P2003-006627A: an eighth conventional example) proposed by the inventor of this application, the image of a high contrast can be obtained by optimally selecting the refractive index of the transparent protection cover.

On the other hand, as the input apparatus of the living body feature in the finger, a technique for authenticating a blood vessel pattern on a finger base side below a first knuckle other than the fingerprint is put to practical use in recent years. This technique uses the absorption of near-infrared light by blood and reads a thick blood vessel pattern such as vein. This is one application of the technique of an optical CT (Computer Tomography) earnestly researched in the 1980s, namely, the technique that tries to perform a so-called computer tomography of a living body by using light harmless for the living body. The blood vessel pattern serves as an effective living body authenticating apparatus when the fingerprint is deteriorated and hard to convert into an image in a living body feature input apparatus in which the contact is assumed, because the fingerprint is lost because of any problem or the husk of the skin is stripped due to dermatitis.

One example of the conventional technique that obtains the blood vessel pattern of the finger together with the fingerprint of the finger is described in the sixth conventional example. This technique uses a fact that an image obtained from the light, which is passed through the finger and emitted from the finger cushion on the opposite side when the near-infrared light are emitted to the finger, includes the blood vessel pattern in addition to the fingerprint pattern. At first, since the line width of the fingerprint pattern the is thinner than the line width of the blood vessel pattern, a smoothing process is performed on a raw image, and the blood vessel pattern is generated by removing the fingerprint pattern to leave the blood vessel image, Next, a difference between the raw image and the blood vessel image is determined, to generate the fingerprint image in which the blood vessel image is removed and only the fingerprint pattern is left.

In recent years, in conjunction with the advancement of information system, the leakage of person information and the spoofing of a different person in a transaction on a network become problematic. In order to prevent occurrence of those problems, an apparatus was developed which inputs a feature of a living body peculiar to a person and authenticates the person, instead of a method that easily allows the spoofing of the different person by stealing or furtively looking at a password or an authentication card. Also, the miniaturization of an information processing apparatus in a lower price represented by a portable phone have been advanced, and the apparatus for inputting the living body feature is also required to be miniaturized and cheapened. Moreover, since the personal authentication using the living body feature is applied for the settlement by using a credit card, the necessity of the higher precision of the living body feature input apparatus is increased more and more, in order to surely authenticate the person under any situation.

The property of the fingerprint that there is no same fingerprint from ancient times and it is never changed in one's life is verified in the police and justice fields, and the person authentication of a high precision is possible by using the fingerprint. However, in the conventional fingerprint input apparatus, it is difficult to obtain an excellent fingerprint image under a bad condition such as a wet or dry state of the finger, and skin peeling caused by dermatitis. Thus, although the fingerprint is not same between all people, it is hardly said to be able to be used for all people.

The fingerprint input method that uses a total reflection critical angle via the fiber optic plate (for example, the first conventional example) or the prism (for example, the second conventional example) is widely used for the personal authentication. However, as described in the related art, since the shade of the fingerprint is generated by the contact between the concave and convex sections of the skin and the prism, the image on the skin peeling portion is lost. Also, the use of the expensive large optical part obstructs the miniaturization and lower price of the apparatus. The image reading apparatus described in the third conventional example contributes to the miniaturization and the lower price, because the optical parts are removed. However, since the shade of the fingerprint is generated by the contact between the concave convex of the skin and the 2-dimensional image sensor plane, the image on the skin separation portion is lost.

With regard to the 2-dimensional sensor of the pressure, electric field or capacitance type, there are several actual use examples. Since the optical parts are removed, this contributes to the miniaturization and the lower price. However, any of them has a contact mechanism as the assumption, and the image on the skin peeling portion is lost. Also, as compared with the optical method, this type of apparatus is weak for the condition change such as the wet or dry-state of the finger.

The technique that uses the quasi 1-dimensional sensor of a pressure, temperature, electric field or capacitance type and slides the finger in contact with the sensor and then reconfigures the image of the fingerprint of the finger (for example, the fourth and fifth conventional example) contributes to the further miniaturization and lower price of the apparatus. However, the image on a non-contact portion is lost. Thus, if the skin is partially stripped because of dermatitis, the fingerprint authentication, namely, the authentication based on the living body feature is difficult. Also, the method that uses the sensor of the 1-dimensional type and moves a reading target and reconfigures the image is already known in a facsimile and a copier. However, this technique has a problem where in order to miniaturize the apparatus, if the special mechanism for getting a speed of a direction in which the finger is moved is omitted, the image reconfiguration precision of the fingerprint is reduced.

As the technique for improving the decrease in the authentication precision caused by the peeling of the skin, a non-contact fingerprint detection apparatus is proposed in the sixth conventional example. According to this proposal, the emission light, which is inputted to the finger and scattered inside the finger and then emitted from the skin surface of the finger, reflects the inner structure of the skin. Thus, the dense/light shape corresponding to the fingerprint is observed. In this proposal, independently of the wet or dry state of epidermis and even when the epidermis horny layer is stripped and dropped because of dermatitis, if the structure of cutis serving as the origin of an epidermis pattern of the fingerprint is reserved, the fingerprint image is obtained. However, in case of the fingerprint detecting apparatus described in the sixth conventional example, a fixing frame for fixing the finger is required and an image forming optical system is also required, which obstructs the operability and miniaturization of the apparatus. Also, the finger and the image forming system are greatly separated.

Thus, even if the inner structure of the finger causes a light quantity emitted from the skin surface to be changed, it is scattered on the skin surface, and the event, which is estimated based on a adverse influence caused due to a spread resulting from the distance of the image forming system, resulting in a problem that the fingerprint image of the excellent contrast is not obtained in the portion where the skin is actually stripped.

On the contrary, in the fingerprint authenticating apparatus (the seventh conventional example) invented by this inventor, the emission light that is emitted from the skin surface after scattered inside the finger is imaged by the 2-dimensional image sensor located closely to the finger, and the fingerprint image is obtained. Then, the miniaturization and lower price of the apparatus are attained. Also, in the technique for reading the 2D scattered emission light from the finger, since the light is once inputted to the inside of the finger, the structure inside the finger is obviously reflected. Thus, in the fingerprint input apparatus according to the seventh conventional example by this inventor, the optical image forming system is removed, thereby attaining some small fingerprint detecting apparatus, and as the phenomenon in the non-contact portion where the skin is stripped, the image in which the inner structure of the skin of the finger is reflected, as pointed out in the sixth conventional example.

On the other hand, the fact that the fingerprint image through the scattered emission light from the finger greatly depends on the boundary state between the skin and the sensor protecting film is clarified by the eighth conventional example related to the proposal of this inventor. That is, the eighth conventional example describes that a refractive index of a transparent cover existing between the fingerprint and the 2-dimensional image sensor placed closely thereto is selected so as to increase the contrast between the bright region corresponding to the convex of the fingerprint in contact with the transparent cover and the dark region corresponding to the concave that is not contact. However, in case of such selection, the influence of the reflection and refraction of the boundary becomes strong which decreases the component reflecting the skin structure. Thus, this has a problem where it is hard to obtain the contrast of the fingerprint image in which the skin structure originally appearing in the skin separation portion is reflected. This problem is especially severe in case where a dynamic range is not widely set. If the non-contact state is kept, the influence of the boundary is removed. However, the configuration for using the fixing frame for the finger and the image forming optical system as proposed in the sixth conventional example brings about the foregoing problem.

On the other hand, as the apparatus for inputting the living body feature existing in the finger, the technique that authenticates a blood vessel pattern on a finger base side below a first knuckle other than the fingerprint can be used as an effective device for authenticating the living body when the fingerprint is absent because of any problem or the fingerprint is deteriorated due to the dermatitis and hard to convert into the image. In particular, if the blood vessel pattern can be read together with the fingerprint pattern, the blood vessel pattern serves as the supplement for the fingerprint information or becomes an effective information source on whether or not the target is the living body. This is effective as a determining method of a spurious finger. However, in the technique according to the sixth conventional example, a space is required between the fingerprint and an image forming optical system, and for the purpose of the necessity of adjusting the focus, a frame for fixing the finger is required, which disturbs the operability and the miniaturization of the apparatus. At the same time, when a smoothing process is performed on the image, there is a possibility that not only the finger pattern but also the thin blood vessel image is lost. Therefore, it is difficult to obtain the blood vessel pattern in a high precision.

### SUMMARY OF THE INVENTION

Therefore, an object of the present invention is to provide an image reading apparatus, which has a small size and a low price and can read a blood vessel pattern of a finger at a high precision by using a 2-dimensional image sensor.

Another object of the present invention is to provide an image reading apparatus that has a small size and a low price and can read a blood vessel pattern and fingerprint pattern of a finger, at a high precision at the same time by using a 2-dimensional image sensor.

In an aspect of the present invention, an image reading apparatus includes first and second light sources configured to emit first and second lights into a detection target, respectively, a 2-dimensional image sensor and a processing unit. The 2-dimensional image sensor has light receiving elements arranged in a matrix, and picks up a light emitted from the detection target through the emission of the first light from the first light source to generate a first image indicating a first pattern corresponding to an internal structure of the detection target, and picks up a light emitted from the detection target through the emission of the second light from the second light, source to generate a second image indicating a second pattern corresponding to a surface pattern of the detection target. The processing unit drives the first and second light sources while switching the first and second light sources, and performs a predetermined process on the first and second images.

At least one of a direction of the emission of the first light and the wavelength of the first light may be set to be adaptive to generate the second imager and at least one of a direction of the emission of the second light and a wavelength of the second light may be set to be adaptive to generate the first image. The first light source may emit the first light of a wavelength band in a near-infrared wavelength range corresponding to an absorption spectrum of hemoglobin.

The first light source and the second light source may be provided on a rear side of the 2-dimensional image sensor. Also, the first light source and the second light source may be provided on a lateral side of the 2-dimensional image sensor. Instead, the first light source and the second light source may be provided above of the 2-dimensional image sensor.

The image reading apparatus may further include a transparent solid film arranged on a top surface of the 2-dimensional image sensor and having a refractive index larger than 1.1 and smaller than 1.4 or larger than 2.0 and smaller than 5.0.

Also, the image reading apparatus may further include partition walls as protrusions configured to keep the detection target in a non-contact state in a predetermined distance from a top surface of the 2-dimensional image sensor. The partition walls desirably form slits. Also, the partition walls may have a light shielding property, or a light transmissible property. In addition, the partition walls may have a refractive index larger than 1.1 and smaller than 1.4 or larger than 2.0 and smaller than 5.0. In this case, the slits may be filled with fillers having a light transmissible property. The fillers preferably have a refractive index larger than 1.1 and smaller than 1.4 or larger than 2.0 and smaller than 5.0. The partition walls and the 2-dimensional image sensor may be unified. The partition walls may be formed in a lattice plate located on or above the top surface of the 2-dimensional image sensor.

Also, the slits may be provided straightly on or above the light receiving elements of the 2-dimensional image sensor. Also, the heights of the partition walls may be in a range of 10 μm to 200 μm.

Also, light emitting devices of the first light source and light emitting devices of the second light source may be arranged in parallel to a direction of vertical scanning of the 2-dimensional image sensor on a rear side of the 2-dimensional image sensor. The light emitting devices other than the light emitting devices near a read target line may be turned on in synchronization with the vertical scanning of the 2-dimensional image sensor.

Also, the processing unit may store a correction image of a reference detection target which has no first and second patterns, and may subtract the correction image from the first and second images read by the 2-dimensional image sensor.

In another aspect of the present invention, an image reading method is achieved by picking up by a 2-dimensional image sensor, light emitted from a surface of a detection target in a state that light is emitted from one of a first light source and a second light source into the detection target provided above the 2-dimensional image sensor which has a plurality of light receiving elements arranged in a matrix, to produce a first image; by picking up by the 2-dimensional image sensor, light emitted from the surface of the detection target in a state that light is emitted from the other of the first light source and the second light source, to produce a second image; and by calculating a difference between the first image and the second image.

According to the present invention, it is possible to read the blood vessel pattern of the finger at the high precision by using the 2-dimensional image sensor. This is because, since two kinds of images of a first image of the blood vessel pattern and a second image of the fingerprint pattern are imaged, and a difference between both of the images is obtained to extract a blood vessel image, it is possible to prevent a loss of the thin blood vessel pattern, differently from the conventional technique in which the fingerprint pattern is removed through a smoothing process of the image and in which only the blood vessel pattern is left.

Also, it is possible to read the fingerprint pattern of the finger together with the blood vessel pattern at a high precision by using the 2-dimensional image sensor. This is because since the detection target and the 2-dimensional image sensor are located in a distance close to each other, the light emitted from the surface of the detection target can be imaged at the excellent contrast.

Moreover, it is possible to miniaturize the apparatus and make the price cheap. This is because the image forming optical system such as lens is not required.

### BRIEF DESCRIPTION OF THE DRAWINGS

FIGS. 1A and 1B are a top view and a lateral sectional view of an image reading apparatus according to a first embodiment of the present invention;

FIG. 2 is a view explaining an inner structure of a skin of a finger;

FIG. 3 is a flowchart showing a reading sequence in the image reading apparatus according to the first embodiment of the present invention;

FIGS. 4A to 4C are diagrams showing a principle in which a blood vessel pattern is read together with a fingerprint pattern by the image reading apparatus according to the first embodiment of the present invention;

FIGS. 5A and 5B are diagrams showing an operation of the image reading apparatus according to the first embodiment of the present invention;

FIG. 6 is a graph showing a relation between a contrast and a refractive index of a transparent solid film existing between the finger and a 2-dimensional image sensor;

FIG. 7 is a lateral sectional view of the image reading apparatus according to a second embodiment of the present invention;

FIG. 8 is a lateral sectional view of the image reading apparatus according to a third embodiment of the present invention;

FIG. 9 is a lateral sectional view of the image reading apparatus according to a fourth embodiment of the present invention;

FIGS. 10A and 10B are a top view and a lateral sectional view showing the image reading apparatus according to a fifth embodiment of the present invention;

FIGS. 11A, 11B and 11C are sectional views showing a relation between a pitch of a light receiving element of the 2-dimensional image sensor and a pitch of a partition wall of a lattice plate;

FIG. 12 is a lateral sectional view of the image reading apparatus according to a sixth embodiment of the present invention;

FIGS. 13A and 13B are diagrams showing the operation of the image reading apparatus according to the fifth and sixth embodiments of the present invention;

FIGS. 14A and 14B are a top view and a lateral sectional view of the image reading apparatus according to a seventh embodiment of the present invention;

FIG. 15 is a diagram showing an operation of the image reading apparatus according to the seventh embodiment of the present invention,

FIG. 16 is a lateral sectional view of the image reading apparatus according to an eighth embodiment of the present invention;

FIG. 17 is a view explaining an operation of the image reading apparatus according to the eighth embodiment of the present invention;

FIGS. 18A and 18B are a top view and a lateral sectional view of the image reading apparatus according to a ninth embodiment of the present invention;

FIG. 19 is a flowchart showing a reading sequence of the image reading apparatus according to the ninth embodiment of the present invention;

FIGS. 20A, 205 and 20C are plan views showing other pattern examples of the partition wall of the lattice plate;

FIGS. 21A and 21B are a top view and a lateral sectional view showing examples of protrusions which carries out a role as a guide so that a skin surface of a finger is kept in a non-contact state at a constant distance from the top plane of the 2-dimensional image sensor;

FIG. 22 is a view explaining a principle of an optical prism method in which a conventional contact is assumed; and

FIGS. 23A and 23B are a top view and a lateral sectional view of a conventional image reading apparatus.

### DESCRIPTION OF THE PREFERRED EMBODIMENTS

Hereinafter, an image reading apparatus according to the present invention will be described in detail with reference to the attached drawings.

### First Embodiment

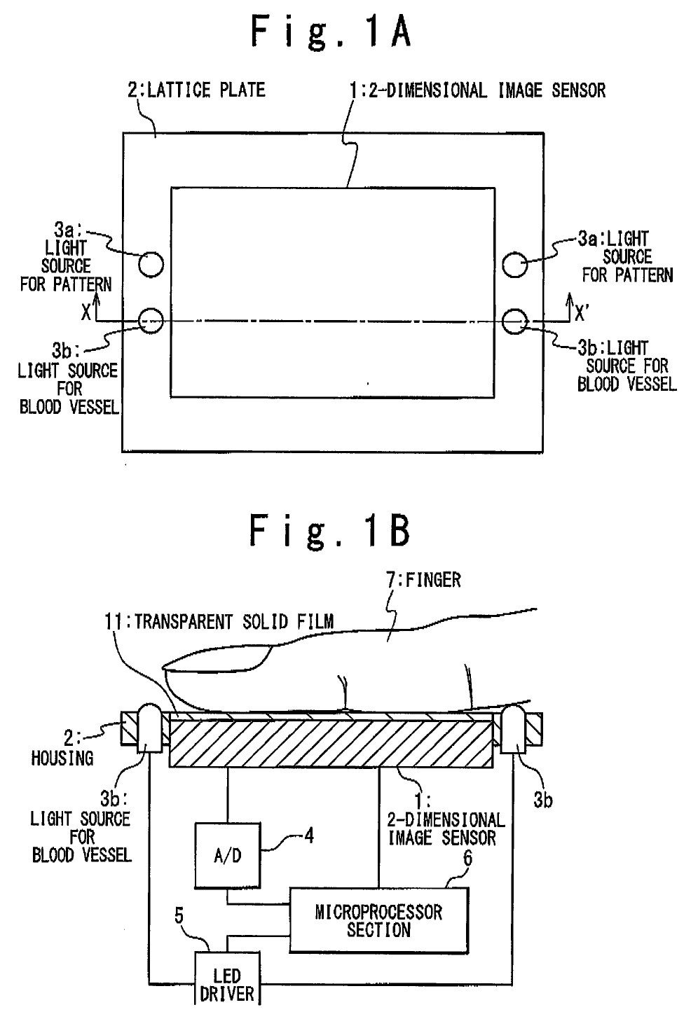

FIGS. 1A and 1B are a top view and a lateral sectional view showing the image reading apparatus according to the first embodiment of the present invention. With reference to FIGS. 1A and 1B, the image reading apparatus according to this embodiment contains: a 2-dimensional image sensor 1 in which a plurality of light receiving elements (not shown) are arranged in a matrix at a pitch that is narrower than a pitch between a ridge section and a valley section in a fingerprint; a light source 3a for a pattern and a light source 3b for a blood vessel, which are provided for openings in a housing 2 of an electronic equipment to which this 2-dimensional image sensor 1 is attached; an A/D converter 4 for converting an analog output signal of the 2-dimensional image sensor 1 into a digital signal; an LED driver 5 for driving the light sources 3a and 3b; and a microprocessor 6 for performing a control of the imaging timing of the 2-dimensional image sensor 1, a control to turn on/off the light sources 3a and 3b, and an imaging process for the digital signal outputted by the A/D converter 4.

As the 2-dimensional image sensor 1, a CCD 2-dimensional image sensor whose sensible wavelength range is between about 200 and 1000 nm and a CMOS 2-dimensional image sensor can be used. In the 2-dimensional image sensor 1, as described in the seventh or eighth conventional example, the plane to be imaged is coated with a transparent solid film 11. A preferable refractive index of the transparent solid film 11 will be described later.

The light source 3a for a pattern is desired to have a wavelength in which a blood vessel image cannot be read but only a skin pattern can be read, unlike the light source 3b. Thus, the light source 3a is composed of the light emitting elements such as LEDs, which emit light of a narrow band in wavelength band other than a near-infrared wavelength range corresponding to the absorption spectrum of the hemoglobin, in the sensible wavelength range of the 2-dimensional image sensor 1. Specifically, the light source 3a is composed of the LEDs, each of which emits the light of the wavelength between about 400 and 700 nm.

The light source 3b for the blood vessel is composed of light emitting elements such as LEDs, which are narrower in wavelength band of emission light and which have an near-infrared wavelength corresponding to an absorption spectrum of hemoglobin that is higher in absorption of the near-infrared rays than the other living body tissues so that a blood vessel image of a finger 7 is clearly read. Typically, the hemoglobin exhibits an excellent absorption between about 800 and 900 nm. The LED developed for an infrared remote controller emits the near-infrared rays whose wavelength is between about 820 and 980 nm and has a large output, which is suitable for the light source 3b.

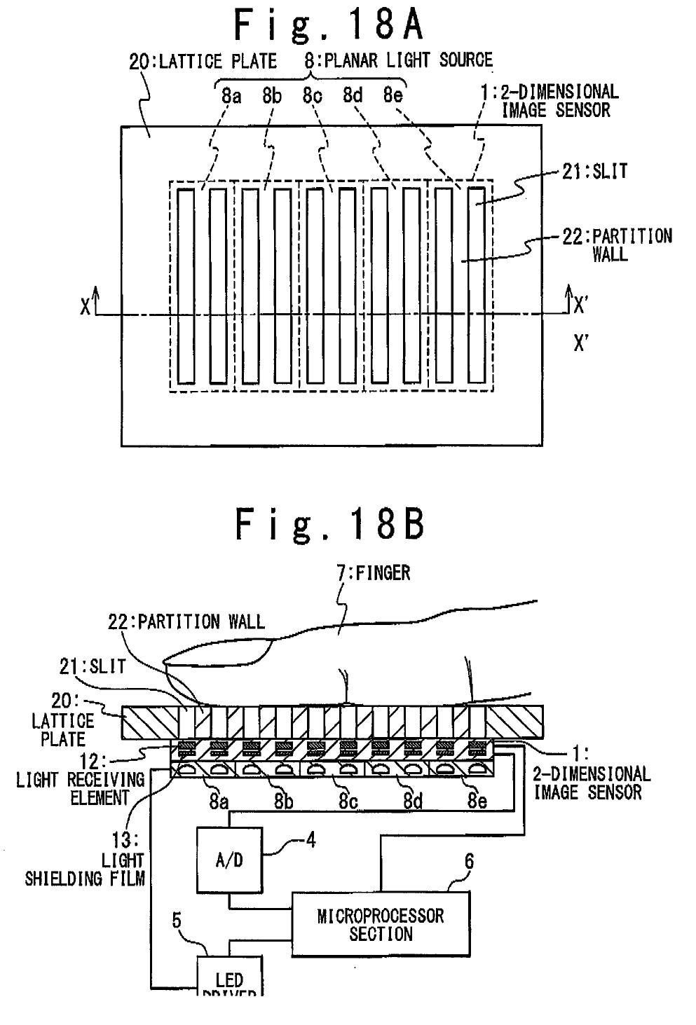

When the image reading apparatus in the first embodiment is used to read the blood vessel image simultaneously with the skin pattern of the finger 7, as shown in FIG. 18, the finger cushion between the tip of the finger 7 and a second knuckle is pushed against the transparent solid film 11 located on or above the top plane of the 2-dimensional image sensor 1. In this situation, the light sources 3a and 3b are switched under the control of the microprocessor 6, and light emitted from the skin surface of the finger 7 is imaged by the 2-dimensional image sensor 1 a plurality of times. An analog signal of the image obtained by the 2-dimensional image sensor 1 is converted into a digital signal by the A/D converter 5 and supplied to the microprocessor 6. The microprocessor 6 inputs the digital signal from the A/D converter 5 and executes a suitable imaging process.

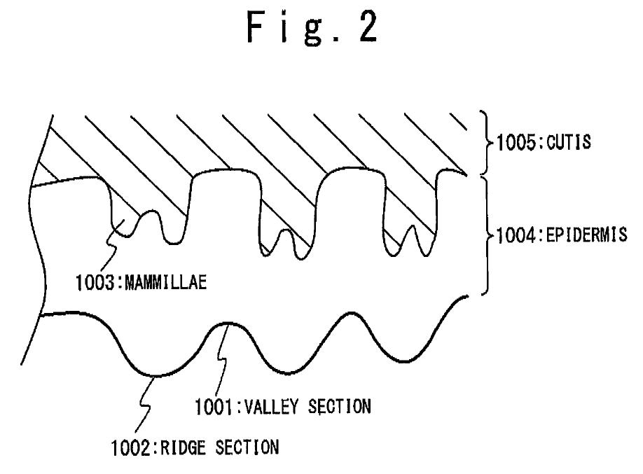

Here, the light, which is scattered inside the finger 7 and emitted from the skin surface of the finger 7, forms a shadow in accordance with the inner structure of the finger shown in FIG. 2. A cutis 1005 is on the inside the finger from an epidermis 1004, and the mammillae 1003 exists below a ridge section 1002 serving as the convex of the fingerprint. The cutis 1005 including the mammillae 1003 includes much water and oil components as compared with the epidermis 1004. Thus, the difference is generated in the refractive index. Because of mammillae protruding to the fingerprint ridge section, the emission light is considered to be decreased in the ridge section 1002, as compared with the valley section 1001 serving as the concave section of the fingerprint. For this reason, among the light receiving elements arranged in the 2-dimensional image sensor 1, the difference in the emission light is generated between the light receiving element located closely to the ridge section 1002 and the light receiving element located closely to the valley 1001 to generate a pattern image. This pattern image is obtained by using any of the light source 3a and the light source 3b. However, an image obtained by using the light source 3b for the blood vessel further includes a blood vessel image in which a blood vessel portion through which blood having the hemoglobin flows is shown darker than other tissues. Therefore, the image resulting by using the light source 3a and the image resulting by using the light source 3b are obtained and a difference between both of the images is determined, so that only the blood vessel image can be extracted.

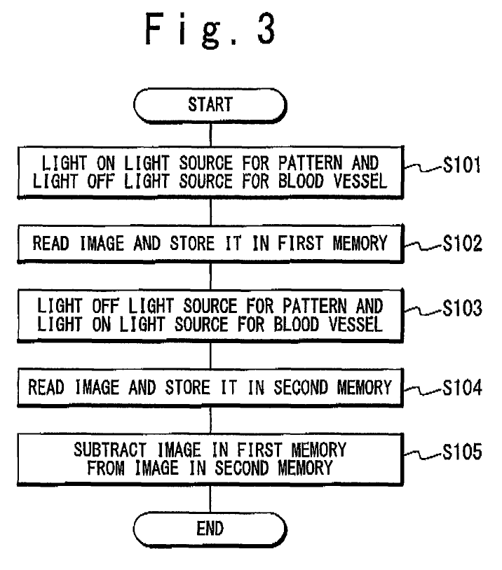

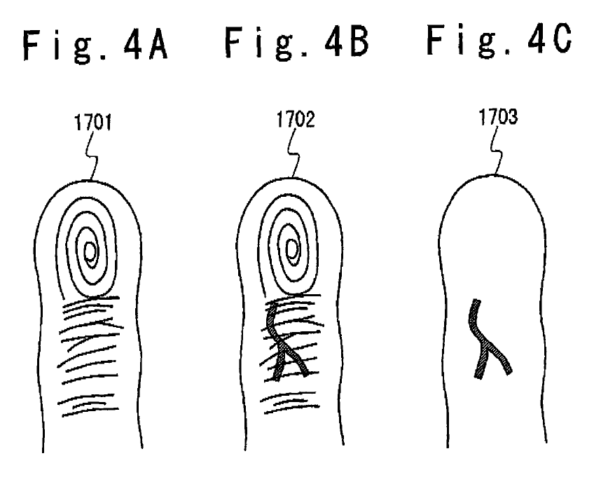

FIG. 3 shows one example of an image read sequence of the microprocessor 6. At first, in a state that only the light source 3a for the pattern is turned on, an image obtained from the 2-dimensional image sensor 1 is read and then written into a first memory (not shown) (Steps S101 and S102). Thus, the image including a skin pattern, for example, as shown as an image 1701 in FIG. 4A, is stored in the first memory. Subsequently, in the situation that only the light source 3b for the blood vessel is turned on, the image of the 2-dimensional image sensor 1 is read and then written to a second memory (not shown) (Steps S103 and S104). Thus, an image containing a pattern image having a skin pattern, and a blood vessel image is stored in the second memory as shown by an image 1702 in FIG. 4B. Finally, the image stored in the first memory is subtracted from the image stored in the second memory (Step S105). Thus, the image including only the blood vessel image is generated as shown as an image 1703 in FIG. 4C. It should be noted that the subtraction between the images at the step S105 is carried out by subtracting one of the pixel values from the other in the pixels of the same position. At this time, if the subtraction result is a value smaller than a predetermined threshold, a process of rounding to 0 may be performed.

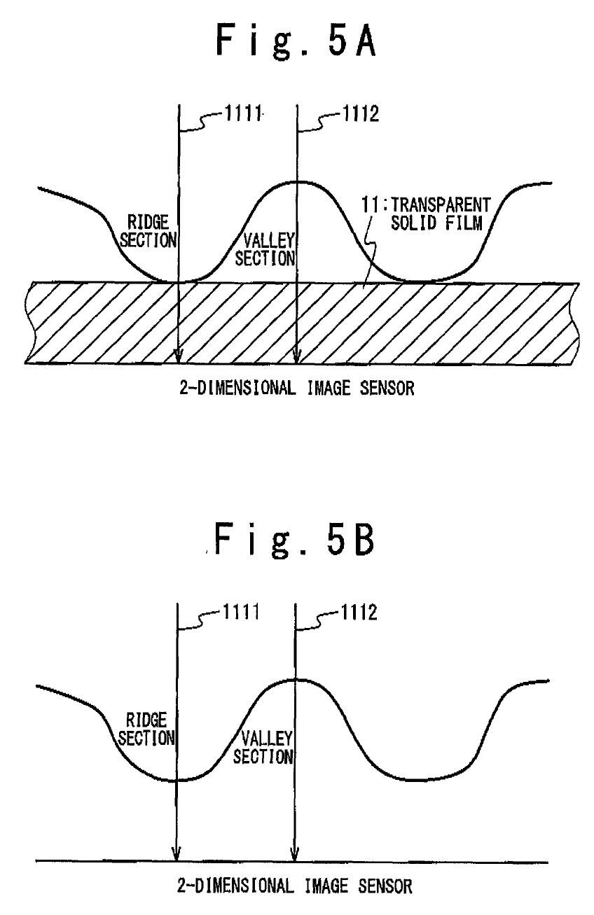

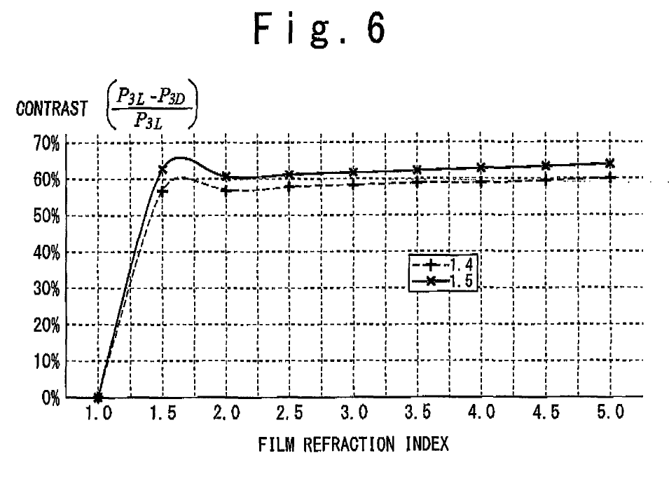

The refractive index of the transparent solid film 11 on the 2-dimensional image sensor 1 will be considered below. FIGS. 5A and 5B are diagrams showing the propagation routes of the lights when the transparent solid film 11 exists on the top plane of the 2-dimensional image sensor 1 and when the film 11 does not exist. When the transparent solid film 11 exists on the top plane of the 2-dimensional image sensor 1, and the finger cushion is pushed in order to read the fingerprint of the finger 7, the skin of the finger 7 is always brought into contact with the transparent solid film 11. For this reason, among the light which is scattered inside the finger and emitted from the skin surface of the finger, a light portion emitted from the fingerprint ridge section in contact with the transparent solid film 11 is directly inputted into the transparent solid film 11 as shown by a numeral 1111 in FIG. 5A, and propagated through the transparent solid film 11 and reaches one light receiving element of the 2-dimensional image sensor 1. Also, a light portion emitted from the fingerprint valley section that is not in contact with the transparent solid film 11 is once inputted into an air layer as shown by a numeral 1112, and propagated through the air layer and then inputted into the transparent solid film 11. After that, the light portion is propagated through the transparent solid film 11 and reaches one light receiving element of the 2-dimensional image sensor 1, similarly to the light portion emitted from the fingerprint ridge section.

On the contrary, when the transparent solid film 11 does not exist, the light portion which is scattered inside the finger and emitted from the skin surface of the finger is once inputted into the air layer, irrespectively of the fingerprint ridge section and the fingerprint valley section, as shown by the numerals 1111 and 1112 in FIG. 5B, and propagated through the air layer and then reaches the light receiving element of the 2-dimensional image sensor 1.

The state shown in FIG. 5B is similar to that of the sixth conventional example. The ridge section is detected as a dark region, and the valley section is detected as a bright region by the 2-dimensional image sensor 1. On the contrary, in case of the interposition of the transparent solid film 11 shown in FIG. 5A, if a refractive index of the transparent solid film 11 is similar to a same value [1] as the air, this is equivalent to the case shown in FIG. 5B in which the transparent solid film 11 does not exist. Thus, the ridge section is detected as the dark region, and the valley section is detected as the bright region by the 2-dimensional image sensor 1. However, if the value of the refractive index of the transparent solid film 11 becomes greater, the relation between the bright and dark regions is reversed, In such a case, the ridge section is detected as the bright region, and the valley section is detected as the dark region by the 2-dimensional image sensor 1. If the refractive index of the transparent solid film 11 is greater, the refractive index difference between the finger 7 and the air and the refractive index difference between the air and the transparent solid film 11 are greater than the refractive index difference between the finger 7 and the transparent solid film 11. Also, until the light portion 1111 emitted from the ridge section shown in FIG. 5A reaches the light receiving element, the light portion passes through the boundary between the finger and the transparent solid film in which the refractive index difference is small. On the other hand, since the light portion 1112 emitted from the valley section passes through the boundary between the finger and the air and the boundary between the air and the transparent solid film in which the refractive index difference is large, the emission light from the valley section is stronger than the light from the ridge section, when the light portion is emitted from the skin surface. However, when the light portion reaches the light receiving element, the light portion sent from the ridge section becomes relatively stronger than the light portion from the valley section. In fact, in the fingerprint input apparatus of the seventh conventional example that uses the 2-dimensional image sensor 1 in which the scattered emission light from the finger is imaged through a transparent protection cover made of glass, the fingerprint image is obtained in which the valley section of the fingerprint serves as the dark region and the ridge section serves as the bright region.

For this reason, when the refractive index of the transparent solid film 11 has a certain value, the contrast between the ridge section and the valley section becomes 0. In this specification, the value of the above refractive index is referred to as a singular point, and the transparent solid film 11 is made of the optically transmissible solid state material having the refractive index of the value except the value of the singular point vicinity. In the eighth conventional example related to the proposal of this inventor, a relation between the contrast and the refractive index of the transparent solid film 11 existing between the finger and the 2-dimensional image sensor is analyzed. According to this analysis, a relation shown in FIG. 6 is derived. In FIG. 6, the vertical axis indicates the contrast that is calculated from (P_{3L-P}_{3D})/P_{3L} when the power of the light inputted to the transparent solid film immediately under the fingerprint ridge section is defined as P_{3L} and the power of the light inputted to the transparent solid film immediately under the fingerprint valley section is defined as P_{3D}. The horizontal axis indicates the refractive index of the transparent solid film. Also, a line connecting the points of + marks is defined when the refractive index of the finger is assumed to be 1.4, and a line connecting the points of x marks is defined when the refractive index of the finger is assumed to be 1.5. However, the graph of FIG. 6 is determined by calculating only the effect resulting from the difference of the refractive index on the boundary between the skin of the finger, the air and the transparent solid film, and this differs from the effect resulting from the structure inside the skin of the finger.

With reference to FIG. 6, when the refractive index of the transparent solid film is 1.0 which is equal to that of the air, the contrast is 0%. This is because in the graph of FIG. 6, the power of the light sent to the ridge section from inside the skin is assumed to be equal to the power of the light sent to the valley section. Originally, when the refractive index is 1.0, a certain degree of contrast is obtained. In the graph of FIG. 6, that contrast value becomes minus. When that contrast is assumed to be C %, the value of the refractive index in which the contrast becomes C % in the graph of FIG. 6 serves as the singular point. Typically, because of C≈10, the singular point=1.1, and in the transparent solid film 11 whose refractive index is 1.1, the contrast between the valley section and the ridge section is 0. Thus, the refractive index of the transparent solid film 11 is required to be between 1.0 and 1.1 or greater than 1.1. The optically transmissible solid state material having the refractive index of 1.1 or less does not substantially exist. Thus, the transparent solid film 11 may be formed of the optically transmissible solid material having the refractive index that is substantially greater than 1.1.

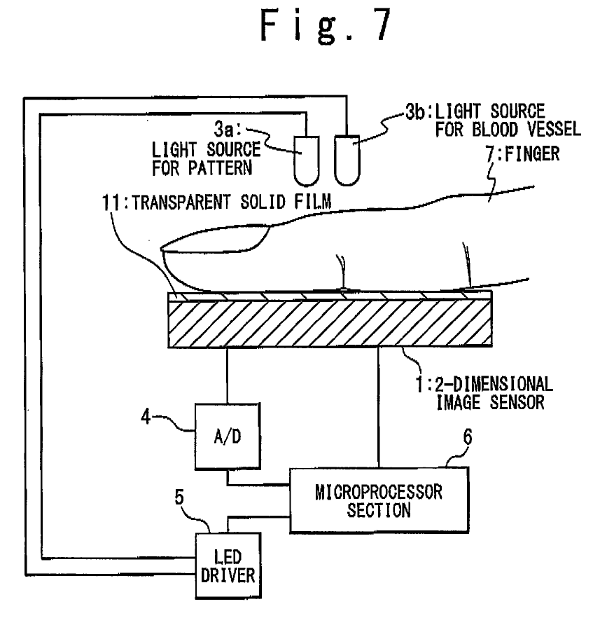

On the other hand, with reference to FIG. 7, in the range in which the refractive index of the transparent solid film is between 1.4 and 2.0, the contrast is especially high. When the entire portion in which the skin is stripped is not in contact with the transparent solid film, the entire portion does not have the same contrast, but the pattern is generated in which the structure inside the finger is reflected. For this reason, if the contrast between the ridge section that contacts with the transparent solid film and the valley section that does not contact is abnormally high as compared with the contrast of the pattern, it is difficult to detect the pattern of the portion in which the skin is stripped when the dynamic range of the sensor is not wide. Therefore, the refractive index in the range between 1.4 and 2.0 in which the contrast is especially high in FIG. 6 is not suitable for the transparent solid film 11.

Moreover, as analyzed in the eighth conventional example related to the proposal of this inventor, when the refractive index of the transparent solid film becomes greater, the brightness is reduced even if the contrast appears, and the S/N ratio is reduced because of noise caused by external disturbance light and noise generated in a circuit act as noise components. Thus, a probability that the identification between the fingerprint ridge section and the fingerprint valley section becomes inaccurate becomes higher. Therefore, the upper limit value of the refractive index is desired to be about 5.0.

As the result of the above-mentioned considerations, the refractive index of the transparent solid film 11 is desired to be between 1.1 and 1.4 or between 2.0 and 5.0.

As the solid material whose refractive index is less than 1.4 and which is suitable for the transparent solid film 11, for example, there is a glass whose main component is BeF₃ (beryllium fluoride). As the solid material whose refractive index is greater than 2.0 and which is suitable for the transparent solid film 11, for example, there are a glass including much BaO (barium monoxide) and PbO (lead oxide), hematite (red steel), rutile (gold red stone), germanium, diamond, or silicon.

As mentioned above, according to the first embodiment, the blood vessel image of the finger 7 can be read at a high precision by using the 2-dimensional image sensor 1. This is because the two kinds of the images of a first image of a skin pattern and a blood vessel pattern and a second image of the skin pattern are imaged, and a difference between the first and second images is determined to extract a blood vessel image. In this way, there is no loss of the thin blood vessel image, differently from the conventional technique for performing a smoothing process for the image of the skin pattern and the blood vessel pattern, and then removing the pattern and consequently leaving only the blood vessel image.

Also, according to the first embodiment, in addition to the blood vessel image, the pattern of the fingerprint of the finger can be read at a high precision by using the 2-dimensional image sensor 1. This is because since the finger 7 and the 2-dimensional image sensor 1 are located at a distance close to each other, a pattern of light emitted from the surface of the finger 7 can be imaged in the excellent contrast. That is, according to the first embodiment, when the contracted optical system described in the sixth conventional example is used, even in a skin peeling portion in which the excellent contrast cannot be obtained by the phenomenon that the light is spread on the skin surface through lens and an optical path, the components that are spread on the skin surface and mixed into each other may be decreased, since the light is inputted from the finger to the 2-dimensional image sensor 1 at the distance close to the finger 7. Moreover, according to this embodiment, the apparatus can be miniaturized and cheapened. This is because the film forming optical system such as the lens is not required.

### Second Embodiment

With reference FIG. 7, the image reading apparatus according to the second embodiment differs from the first embodiment shown in FIG. 1 in which the light for a fingerprint pattern and a blood vessel pattern is emitted from the side of the finger 7. In the second embodiment, the light source 3a for the fingerprint pattern and the light source 3b for the blood vessel pattern are arranged at the positions opposite to the 2-dimensional image sensor 1 to put the finger 7 serving as the detection sample between the 2-dimensional image sensor 1 and the light sources 3a and 3b. The other components are same as those of the first embodiment.

As the configuration in which the light sources 3a and 3b are supported above the finger 7, the configuration may be considered in which a cavity having a size to a degree that the finger 7 can be inserted is provided in the housing, the 2-dimensional image sensor 1 is placed on the bottom of the cavity, and the light sources 3a and 3b are attached to a ceilings Of course, the attachment structure of the light sources 3a and 3b may have any structure other than it.

In an example of FIG. 7, the number of light emitting elements of the light source 3a for the fingerprint pattern is one and the number of light emitting element of the light source 3b for the blood vessel pattern is one. However, the plurality of light emitting elements in each of the light sources 3a and 3b may be provided.

According to the second embodiment, the light emitted from the light source 3b for the blood vessel pattern is inputted from the rear of the finger 7 into the finger and propagated through the finger and emitted from the skin surface of the finger cushion of the finger 7. Thus, as compared with a case that the light is emitted from the side of the finger 7 as described in the first embodiment, the clearer blood vessel image can be obtained.

### Third Embodiment

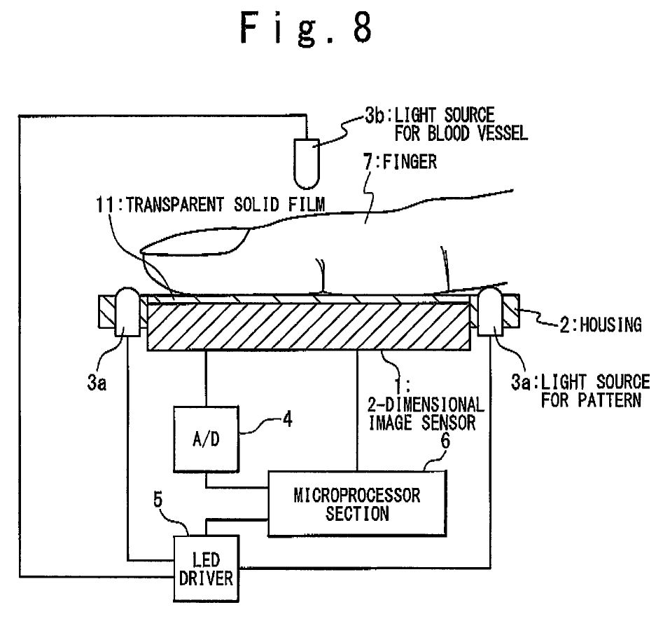

With reference FIG. 8, the image reading apparatus according to the third embodiment differs from the first embodiment shown in FIG. 1 in which the light for the blood vessel pattern is emitted from the side of the finger 7. In the third embodiment, the light source 3b for the blood vessel pattern is arranged at a position opposite to the 2-dimensional image sensor 1 to put the finger 7 serving as the detection sample between the light source 3b and the 2-dimensional image sensor 1. Thus, the light for the blood vessel pattern is emitted from the rear of the finger 7. The other components are same as those of the first embodiment.

The configuration in which the light source 3b is supported above the finger 7 may be similar to that of the second embodiment. In an example of FIG. 7, the number of light emitting elements of the light source 3b for the blood vessel pattern is one. However, the plurality of light emitting elements of the light sources 3b may be provided.

According to the third embodiment, the light emitted from the light source 3b for the blood vessel pattern is inputted from the rear of the finger 7 into the finger and propagated through the finger and emitted from the skin surface of the finger cushion of the finger 7. Thus, as compared with a case that the light is emitted from the side of the finger 7 as described in the first embodiment, the clear blood vessel image can be obtained. Also, since the light source 3a for the fingerprint pattern emits the light from the side of the 2-dimensional image sensor 1, it is possible to substantially remove the blood vessel image as compared with the second embodiment in which the light is emitted from the rear of the finger 7.

### Fourth Embodiment

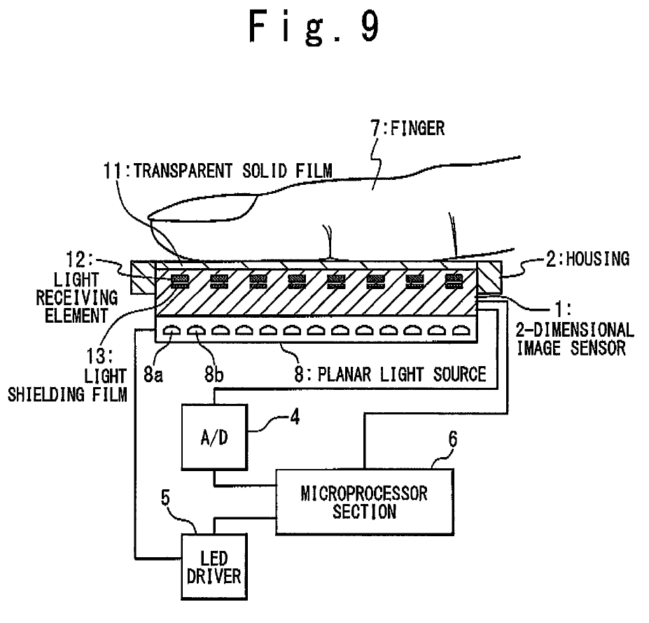

With reference to FIG. 9, the image reading apparatus according to the fourth embodiment of the present invention differs from the first embodiment shown in FIG. 1 in which the lights for the fingerprint pattern and the blood vessel pattern are emitted from the side of the finger 7. In the fourth embodiment, the image reading apparatus contains a planar light source 8 which is arranged on the rear of the 2-dimensional image sensor 1 and emits a uniform light to the finger 7 in contact with the transparent solid film 11; and a light shielding film 13 provided on the rear of each of the light receiving elements 12 to shield the light towards each of light receiving elements 12 from the planar light source 8. The other components are same as those of the first embodiment.

The light shielding film 13 can be realized by forming a gate electrode on a bottom side of a material capable of shielding light, when a thin transistor having a double-gate structure is used in which a photo sensing function and a selection transistor function are given to a photo sensor itself, as described in the third conventional example as the light receiving element 12. Also, as the planar light source 8, it is possible to use the structure in which LEDs 8a for the fingerprint pattern and LEDs 8b for the blood vessel pattern are alternately arranged in an array, they can be controlled to be turned on/off independently of each other, and a light scattering plate made of a frosted glass is attached thereon. According to the fourth embodiment, since the planar light source 8 is placed on the rear of the 2-dimensional image sensor 1, the planar space occupied by the reading apparatus can be reduced,

As mentioned above, the several configuration examples applicable to the present invention have been illustrated. However, relatively at least one of an emission direction and a wavelength of the light source for the fingerprint pattern may be set such that the blood vessel image is hard to image, and at least one of the emission direction and the wavelength of the light source for the blood vessel pattern may be set such that the blood vessel image is easy to image. Thus, when the light source for the blood vessel pattern may be placed at the position in which the finger is illuminated from the side opposite to the 2-dimensional image sensor and the light source for the fingerprint pattern is placed at the position in which the finger is illuminated from the side or bottom of the finger, the light source for the pattern. Also, the light source for the blood vessel pattern may be the light source having the same wavelength (for example, the near-infrared rays between about 820 and 980 nm).

The above respective embodiments use the 2-dimensional image sensor whose top plane is coated with the transparent solid film. However, instead of the transparent solid film, it is possible to use a 2-dimensional image sensor in which a plurality of protrusions are formed to keep a detection sample such as the finger in a non-contact state at a constant close distance from the top plane of the 2-dimensional image sensor. The embodiment using such a 2-dimensional image sensor will be described below.

### Fifth Embodiment

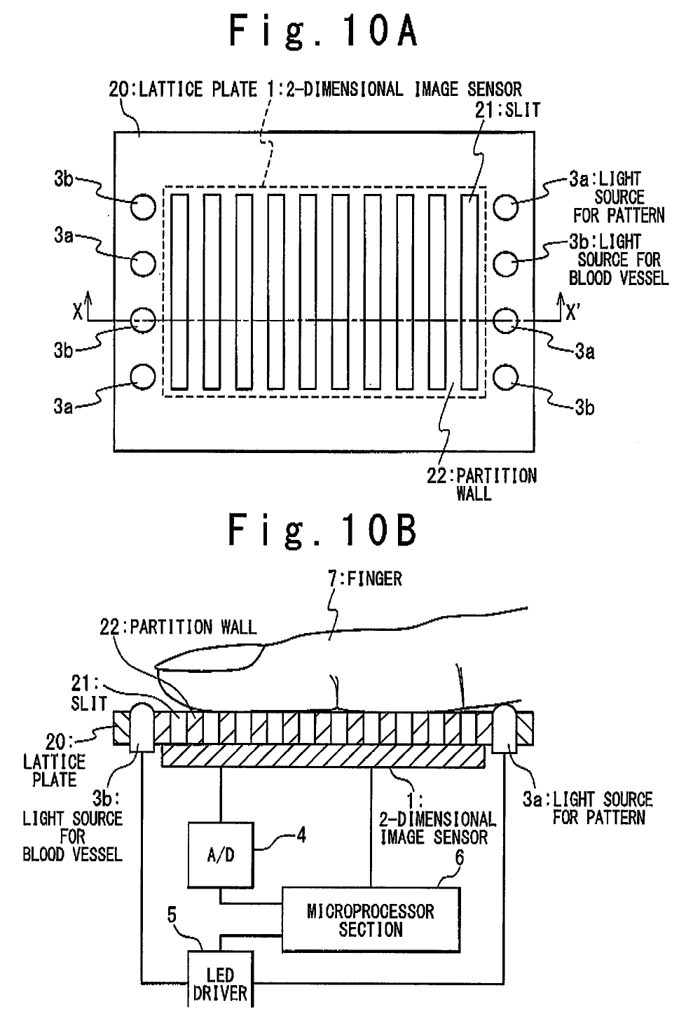

With reference to FIGS. 10A and 10B, the image reading apparatus according to the fifth embodiment has, on a central portion, a plurality of partition walls (protrusions) 22 arranged in parallel to form a large number of slits 21 and contains a lattice plate 20 in which the bottom planes of the partition walls 22 are adhesively attached to the top plane of the 2-dimensional image sensor 1. The light source 3a for the fingerprint pattern and the light source 3b for the blood vessel pattern are attached to the openings formed on the periphery of the lattice plate 20.

The lattice plate 20 is formed of a plate material having a light shielding property such as a metal plate which is thinly processed and the slits 21 are formed on a central portion. When the finger 7 serving as the detection sample is placed on the 2-dimensional image sensor 1, the partition walls 22 play a role as a guide so that the skin surface of the finger 7 is kept to the non-contact state in a constant distance from the top plane of the 2-dimensional image sensor 1. In order to keep the non-contact state, as the width of the slit 21 is wider, the height of the partition wall 22 is required to be higher. However, if the height of the partition wall 22 becomes 200 μm or more, the unclearness of the image becomes severe. Also, if the width of the slit 21 becomes narrower than a pitch of the light receiving elements, the light receiving quantity becomes small, Since the actual size is related to a pitch of the light receiving elements in the 2-dimensional image sensor 1, the height of the partition wall 22, the width the slit 21 and the pitch of the slits 21 are determined by considering various conditions.

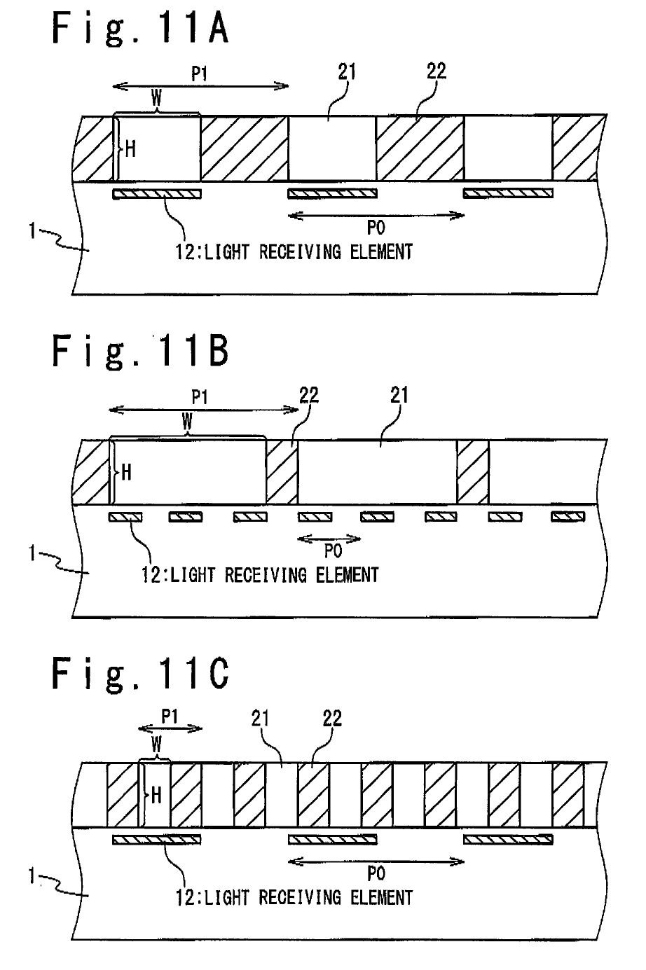

For example, as shown in FIG. 11A, when the structure in which a pitch P0 of the light receiving elements 12 in the 2-dimensional image sensor 1 and a pitch P1 of the partition walls 22 are made equal to perform the positioning, a width W of the slit 21 may be set to be approximately equal to the light receiving diameter of the light receiving element 12, and a height H of the partition wall 22 may be set to be equal to or greater than the slit width W and 200 μm or less. In this case, in the 2-dimensional image sensor 1 in which the light receiving elements 12 each having the light receiving diameter of 25 μm, are arranged at 500 DPI, for example, P1=about 50 μm, W=about 25 μm, and H=about 25 μm to about 200 μm.

Also, as shown in FIG. 11D, it is allowable to employ the structure in which the pitch P1 of the partition walls 22 is set to be n times (n is a positive integer of 2 or more) the pitch P0 of the light receiving elements 12 in the 2-dimensional image sensor 1 and the positioning is carried out. In this case, in the 2-dimensional image sensor 1 in which the light receiving elements 12 each having the light receiving diameter of 25 μm, are arranged at 500 DPI, for example, P1=about 150 μm, W=about 125 μm, and H=about 125 μm to about 200 μm.

Moreover, when the pitch P1 of the partition walls 22 is set to be shorter than a half of the pitch P0 of the light receiving elements 12 in the 2-dimensional image sensor 1, at least one slit 21 can be correlated to each light receiving element 12, as shown in FIG. 11C. Thus, it is not required to perform the accurate positioning between the slit 21 and the light receiving element 12, such as a case of FIGS. 11A and 11B. In this case, in case of the 2-dimensional image sensor 1 in which the light receiving elements 12 each having the light receiving diameter of 25 μm are arranged at 500 DPI, when P=about 20 μm is defined W=about 10 μm and H=about 10 μm to about 200 μm.

When the image reading apparatus in the fifth embodiment is used to read the fingerprint pattern and blood vessel pattern of the finger 7, as shown in FIG. 10B, the finger cushion in the range between the tip of the finger 7 and the second knuckle is pushed against the partition walls 22 of the lattice plate 20 located above the 2-dimensional image sensor 1. In the degree that the finger cushion is lightly pushed, both of the lateral finger cushion regions of the finger 7 are not brought into contact with the partition wall 22. However, when the cushion of the finger is strongly pushed, the elasticity of the skin makes the cushion of the finger 7 flat so that the entire finger cushion is brought into contact. Even at this time, the non-contact state between the skin of the finger 7 and the top plane of the 2-dimensional image sensor 1 is held by the partition walls 22.

In this state, perfectly similar to the first embodiment, the light sources 3a and 3b are switched under the control of the microprocessor 6, and the image through the emission light emitted from the skin surface of the finger 7 is imaged a plurality of times by the 2-dimensional image sensor 1. Then, a difference between the images is determined, to extract the blood vessel image together with the finger image. In case of the fifth embodiment, the fingerprint ridge section serves as the dark region, and the valley section serves as the bright region in the fingerprint pattern image.

According to this embodiment, by using the 2-dimensional image sensor 1 without using the unnecessary optical part, together with the blood vessel image of the finger 7, the fingerprint pattern image of the skin in which the inner structure of the finger 7 is directly reflected can be stably read without any influence of the wet or dry state of the finger 7. Also, the apparatus can be simplified and miniaturized. This reason results from a mechanism in which the light sources 3a and 3b are switched in the situation that the finger 7 is kept in the non-contact state in the constant distance from the top plane of the 2-dimensional image sensor 1 by the partition walls 22 of the lattice plate 20 and the emission light emitted from the skin surface of the finger 7 is imaged a plurality of times, and a difference between the images is determined, to read the blood vessel image together with the fingerprint image.

Moreover, in case of the fifth embodiment, the moderate friction force is generated between the partition walls 22 and the finger 7. Thus, the movement of the finger 7 during the imaging can be suppressed, resulting in obtaining the pattern image without any blurring.

### Sixth Embodiment

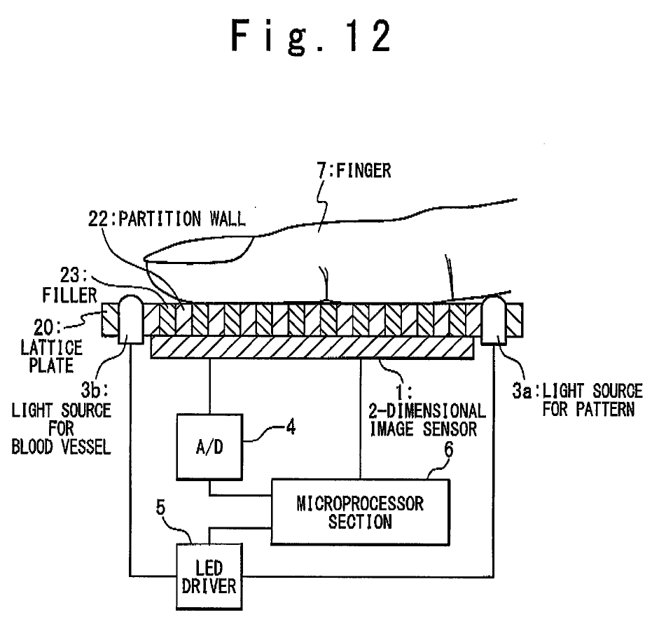

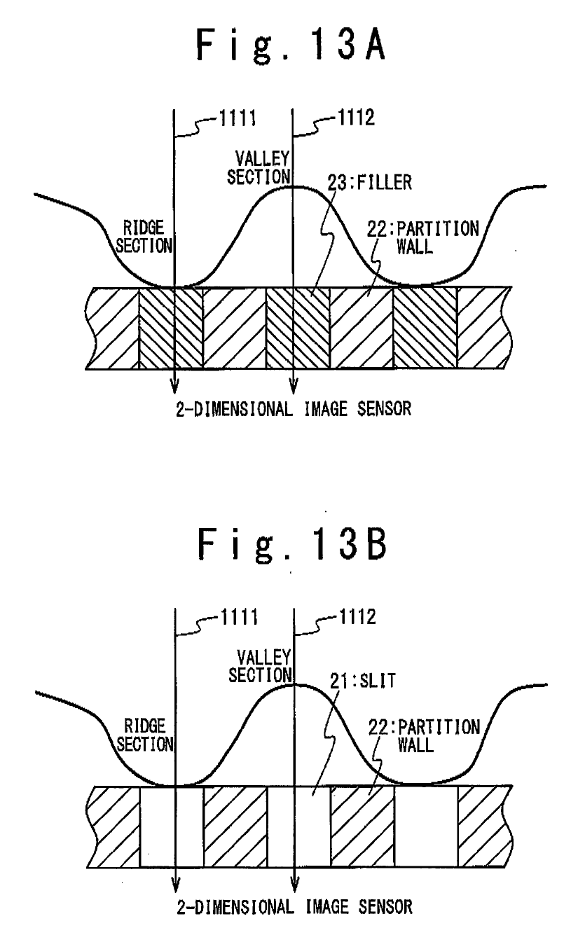

With reference to FIG. 12, the image reading apparatus according to the sixth embodiment differs from the fifth embodiment shown in FIGS. 10A and 10B, in that a filler 23 of optically transmissible solid material is inserted into each of the slits 21 of the lattice plate 20. The bottom planes of the fillers 23 are adhered to the top plane of the 2-dimensional image sensor 1, and the top plane of the filler 23 is the same plane as the top plane of the partition walls 22. Thus, in order to read the fingerprint pattern and blood vessel pattern of the finger 7, when the finger cushion is pushed against the partition walls 22 of the lattice plate 20, the skin of the finger 7 is brought into contact with the fillers 23. For this reason, the light is scattered inside the finger and emitted from the skin surface of the finger, and then the light emitted from the fingerprint ridge section in contact with the fillers 23 is directly inputted to the fillers 23, as shown by a numerals 1111 in FIG. 13A, and propagated through the fillers 23 and reaches the light receiving element in the 2-dimensional image sensor 1. Also, the light emitted from the fingerprint valley section that is not in contact with the fillers 23 is once inputted to an air layer, as shown by a numeral 1112, and propagated through the air layer and then inputted to the fillers 23. After that, similarly to the light emitted from the fingerprint ridge section, the emission light is propagated through the filler 23 and reaches the light receiving element in the 2-dimensional image sensor 1.

On the contrary, in case of the fifth embodiment in which the filler 23 does not exist in the slit 21, the light that is scattered inside the finger and emitted from the skin surface of the finger is once inputted to the air layer and propagated through the air layer and then reaches the light receiving element in the 2-dimensional image sensor 1, as shown by the numerals 1111 and 1112 in FIG. 13B, independently of the fingerprint ridge section and the fingerprint valley section.

In case of the fifth embodiment shown in FIG. 13B, as mentioned above, the ridge section is detected as the dark region, and the valley section is detected as the bright region by the 2-dimensional image sensor 1. On the contrary, in case of the interposition of the fillers 23 shown in FIG. 13A, if a refractive index of the filler 23 is similar to the same value of “1” as the air, this is equivalent to FIG. 13B in which the filler 23 does not exist. Thus, the ridge section is detected as the dark region, and the valley section is detected as the bright region by the 2-dimensional image sensor 1. However, if the value of the refractive index of the filler 23 becomes greater, the relation between the bright and dark regions is reversed. Then, the ridge section is detected as the bright region, and the valley section is detected as the dark region by the 2-dimensional image sensor 1. This reason is same as the first embodiment in which the top plane of the 2-dimensional image sensor 1 is coated with the transparent solid film 11. Therefore, the filler 23 can have the same material and refractive index as those of the transparent solid film 11.

In this way, according to the sixth embodiment, in addition to the obtainment of the effect similar to that of the fifth embodiment, there is the effect in which as compared with the fifth embodiment, dust is hard to deposit, since the top plane of the lattice plate 20 is flat, and even if the dust is deposited, there is no fear that the dust is deposited on the slit 21 and the image quality is deteriorated, since the cleaning is easy.

### Seventh Embodiment

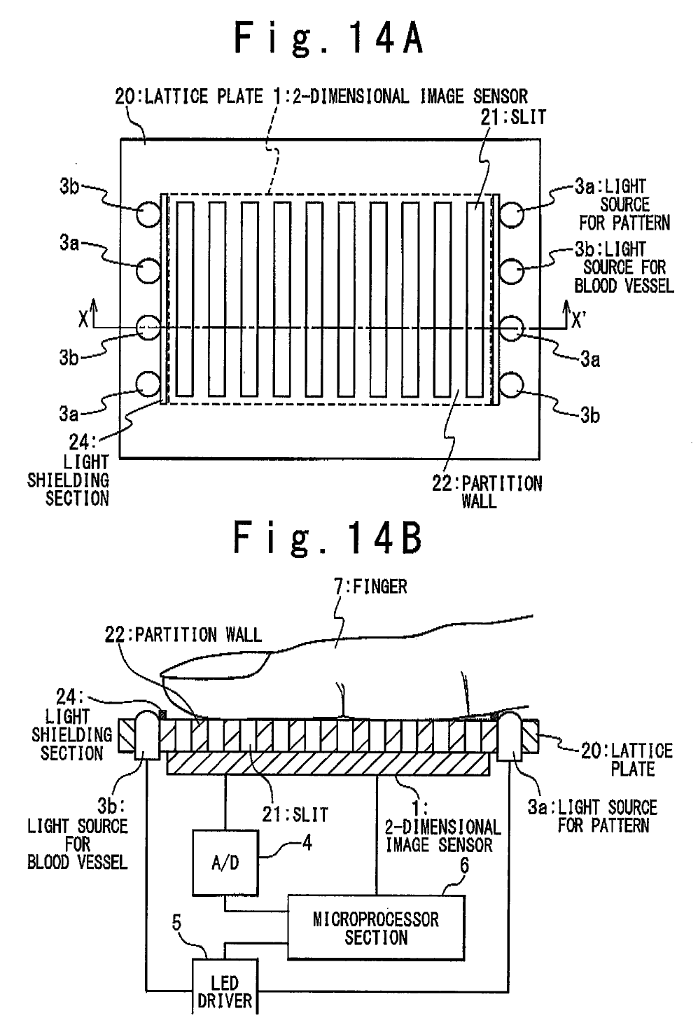

With reference to FIGS. 14A and 14B, the image reading apparatus according to the seventh embodiment differs from the fifth embodiment, in that the whole of the lattice plate 20 or at least a portion of the partition wall 22 is optically transmissible. As the optically transmissible material used for the partition wall 22, it is possible to use the material similar to material used in the filler 23 in the sixth embodiment. The condition of the refractive index can be similar to that of the filler 23. If the lattice plate 20 is optically transmissible, light shielding sections 24 are desired to be provided to shield the light that are sent from the light sources 3a and 3b through the lattice plate 20 to the light receiving elements in the 2-dimensional image sensor 1.

In case of this embodiment, the light emitted from the finger 7 is inputted to the 2-dimensional image sensor 1 through the optically transmissible partition walls 22 as shown by a numeral 1113, in addition to the route in which the light is inputted to the 2-dimensional image sensor 1 through the slit 21 as shown by the numerals 1111 and 1112 of FIG. 15. Thus, this has a merit that the pitch of the partition walls 22 is not required to be set in position to the pitch P0 of the light receiving elements 11 in the 2-dimensional image sensor 1 as shown in FIGS. 11A and 11B, and the pitch of the partition walls 22 is not required to be equal to or less than a half of the pitch of the light receiving elements as shown in FIG. 11C.

As can be estimated from the fact that the bright/dark regions relation between the fingerprint ridge section and the fingerprint valley section that is obtained by the 2-dimensional image sensor 1 is opposite between the fifth and sixth embodiments. In the seventh embodiment, the fingerprint ridge section corresponding to the slit 21 and the fingerprint valley section serve as the bright region and the dark region, and the fingerprint ridge section in contact with the partition wall 22 and the fingerprint valley section opposite to the partition wall 22 serve as the dark region and the bright region, respectively. Thus, the bright region and the dark region are inverted for each location. However, this problem can be solved by a method of an imaging process and the fingerprint authentication. That is, through the edge emphasis, only the continuity of the ridge section may be extracted and linked. Also, when the authenticating method based on the positional relation between the feature points such as the branch point and end point of the fingerprint is employed as the authenticating method, the reversion of the bright/dark relation has no influence on the authentication.

### Eighth Embodiment

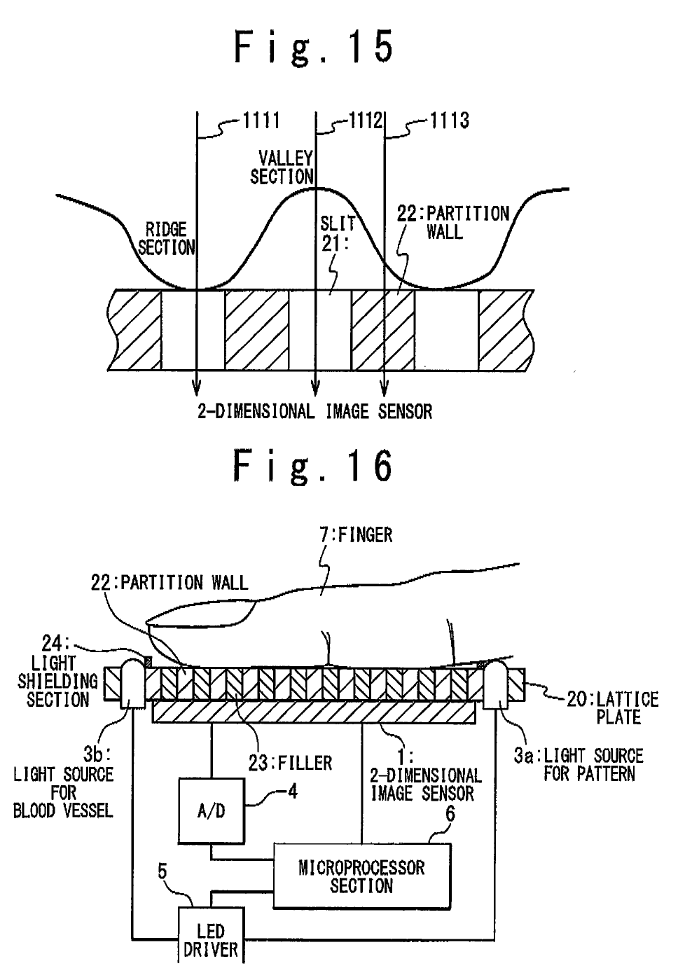

With reference to FIG. 16, the image reading apparatus according to the eighth embodiment differs from the sixth embodiment, in that the whole of the lattice plate 20 or at least a portion of the partition wall 22 is optically transmissible. As the optically transmissible material used for the partition wall 22, it is possible to use a material similar to the material used for the filler 23. The condition of the refractive index can be similar to that of the filler 23, In this case, in addition to the use of the perfectly same material and refractive index, the material and the refractive index may be different between the filler 23 and the partition walls 22. If the lattice plate 20 is optically transmissible, the light shielding sections 24 are desired to be provided to shield the light that are emitted from the light sources 3a and 3b through the lattice plate 20 to the light receiving elements in the 2-dimensional image sensor 1.

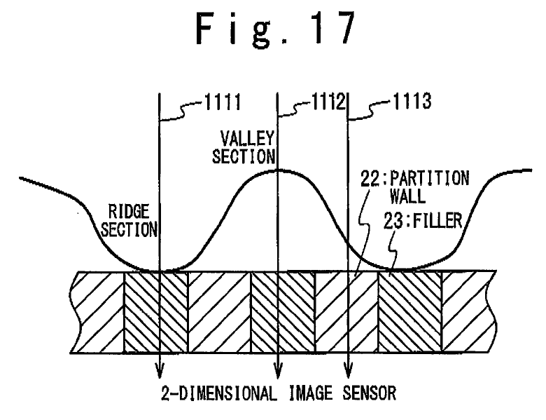

In case of the eighth embodiment, the light emitted from the finger 1 is inputted to the 2-dimensional image sensor 1 through the optically transmissible partition walls 22 as shown by the numeral 1113, in addition to the route in which the light is inputted to the 2-dimensional image sensor 1 through the fillers 23 of the slits 21 as shown by the numerals 1111 and 1112 of FIG. 17. Thus, this has a merit that the pitch of the partition walls 22 is not required to be set to the pitch P0 of the light receiving elements 11 in the 2-dimensional image sensor 1 as shown in FIGS. 11A and 11B, and the pitch of the partition walls 22 is not required to be equal to or less than a half of the pitch of the light receiving elements as shown in FIG. 11C.

Also, in case of the eighth embodiment, there is a merit that both of: the fingerprint ridge section in contact with the fillers 23 and the fingerprint valley section opposite to the fillers 23; and the fingerprint ridge section in contact with the partition walls 22 and the fingerprint valley section opposite to the partition walls 22 serve as the bright region and the dark region.

### Ninth Embodiment

With reference to FIGS. 18A and 18B, the image reading apparatus according to the ninth embodiment differs from the seventh embodiment, in that the image reading apparatus contains a planar light source 8 which is placed on the rear of the 2-dimensional image sensor 1 and emits a uniform light to the finger 7 in contact with the lattice plate 20, instead of the light sources 3a and 3b arranged in the periphery of the lattice plate 20; and light shielding films 13 which are arranged on the rear of the light receiving elements 12 in the 2-dimensional image sensor 1 to shield the light from the planar light source 8 to the light receiving elements 12, instead of the light shielding sections 24. The light shielding film 13 can be attained in such a way that the gate electrode on a bottom side is made of a material which shields the light, in case of using the thin film transistor which has a double-gate structure in which a photo sensing function and a selection transistor function are given to the photo sensor itself, as described in the third conventional example as the light receiving element 12.

The planar light source 8 is formed by arranging a plurality of planar light emitting devices 8a to 8e of the planar light source, which can be controlled to be turned on/off independently of each other, in a line in the vertically scanning direction (the right/left direction in FIGS. 18A and 18B) of the 2-dimensional image sensor 1. The individual planar light emitting devices 8a to 8e can use the structure, in which the LEDs for the fingerprint pattern having the wavelength between 400 and 700 nm and the LEDs for the blood vessel pattern having the wavelength between 820 and 980 nm (both of them are not shown), which can be controlled to be turned on/off independently of each other, are alternately arranged in an array, and the light scattering plate made of the frosted glass is attached thereon.

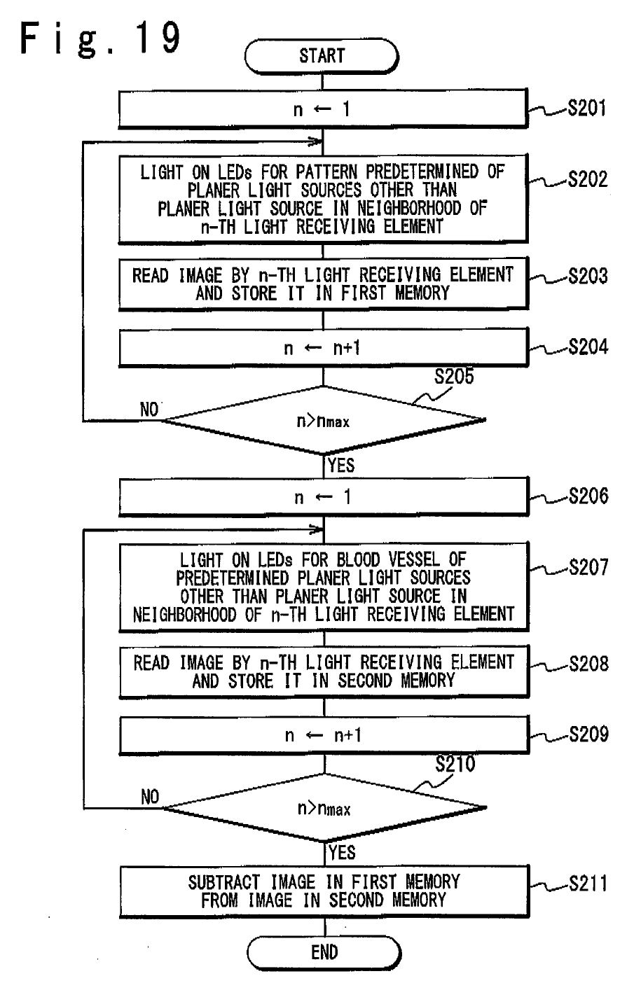

FIG. 19 shows one example of a reading sequence of the image reading apparatus according to the ninth embodiment. This sequence is controlled by the microprocessor 6. In a situation that the finger cushion of the finger 7 is pushed against the partition walls 22 of the lattice plate 20 located on or above the 2-dimensional image sensor 1, the reading control of the microprocessor 6 is started.

At first, a variable n to manage a read target row is set to one, and among the light receiving elements composed of a plurality of rows contained in the 2-dimensional image sensor 1, the light receiving element on the first row is assumed to be a read target (Step S201). At this time, the light, which is emitted from the planar light source and reflected on the skin surface of the finger, is not inputted to the light receiving elements on the first row serving as the read target among the planar light emitting devices 8a to 8e. Only a predetermined planar light source except the planar light sources near the read target row is turned on (Step S202). For example, in FIGS. 11A and 18s, if the light receiving elements on the first row exists on the left side of the paper, the planar light emitting device 8a is turned off, and all of the remaining planar light emitting devices 8b to 8e are turned on. Or, a part of the remaining planar light sources may be turned on, as only the planar light emitting device 8b. Moreover, all of the LEDs in the planar light sources may not be turned on, and only the LED for the fingerprint pattern may be turned on, and the LED for the blood vessel pattern is turned off. In this situation, the read operation through the light receiving element on the first row is performed, and the image is stored in the first memory (Step 8203) Specifically, after the light receiving elements on the first row is once reset, an optically accumulating operation is started. The reading operation is then executed. When the reading operation of the light receiving elements on the first row has been completed, the variable n is increased by +1 and changed to 2 (Step S204). The light receiving elements on a second row is read similarly to the light receiving elements on the first row. Also, at this time, in the situation that the planar light source near the read target row is turned off and only the LED for the pattern among the remaining predetermined planar light sources is turned on, the reading is executed. When the operation similar to the foregoing operation performed on the first and second rows is repeatedly performed on all of the remaining rows and completed (Step S205: YES), the image shown in 1701 of FIG. 4 is stored in the first memory.

In succession, the variable n to manage the read target row is set to one, and the light receiving elements on the first row in the 2-dimensional image sensor 1 is again assumed to be the read target (Step S206). Also, at this time, the light, which is emitted from the planar light source and reflected on the skin surface of the finger, is not inputted to any light receiving element on the first row serving as the read target among the planar light emitting devices 8a to 8e. Only the predetermined planar light emitting devices other than the planar light emitting devices near the read target row are turned on. However, differently from the previous time, only the LED for the blood vessel pattern is turned on, and the LED for the fingerprint pattern is turned off (Step S207). In this situation, the reading operation through the light receiving elements on the first row is performed, and the image is stored in the second memory (Step S208). When the reading operation of the light receiving elements on the first row has been completed, the variable n is increased by +1 and changed to 2 (Step S209). The light receiving elements on the second row is read similarly to the light receiving elements on the first row. Also, at this time, in the situation that the planar light emitting devices near the read target row are turned off and only the LED for the blood vessel pattern among the remaining predetermined planar light emitting devices is turned on, the reading operation is performed. When the operation similar to the foregoing operations performed on the first and second rows is repeatedly performed on all of the remaining row and completed (Step S210: YES), the image shown by 1702 in FIG. 4 is stored in the second memory,

Finally, the image stored in the first memory is subtracted from the image stored in the second memory (Step S211). Thus, the image including only the blood vessel image such as the image 1703 in FIG. 4 is generated. It should be noted that the subtraction between the images at the step S211 is performed by subtracting the image value between the pixels of the same position. At this time, if the subtraction result is the value smaller than a predetermined threshold, a process of rounding to 0 may be performed. In this way, according to this embodiment, since the planar light source 8 is provided on the rear of the 2-dimensional image sensor 1, the flat space occupied by the reading apparatus can be decreased.

Also, according to the ninth embodiment, the reading operation is performed in the situation that the predetermined planar light emitting devices other than the planar light emitting devices near the read target row of the 2-dimensional image sensor 1, it is possible to prevent the light, which is emitted from the planar light source 8 and reflected on the skin surface of the finger, from being inputted to the light receiving element, and also possible to prevent the decrease in the contrast between the ridge section and the valley section. That is, in the reading operation through the slits 21, as described in the fifth embodiment, the fingerprint valley section serves as the bright region, and the fingerprint ridge section serves as the dark region. However, the illumination from below the slits 21 causes the fingerprint ridge section to be brightly illuminated, as compared with the fingerprint valley section. Thus, this leads to the decrease in the contrast.

In the ninth embodiment, the partition walls 22 are made of the optically transmissible material so that the light from the planar light source 8 is excellently sent to the finger 7. However, since there is the light that is inputted to the finger 7 from the slits 21 located above the planar light source 8 in the on state, the partition walls 22 may be made of the light shielding material, similarly to the fifth embodiment. Also, the filler 23 similar to the sixth embodiment may be inserted into the slits 21. In this case, in the reading operation through the filler 23, as described in the sixth embodiment, the fingerprint valley section serves as the dark region, and the fingerprint ridge section serves as the bright region. Thus, the illumination from below the filler 23 allows the contrast between the fingerprint valley section and the fingerprint ridge section to be further emphasized. Therefore, the control for turning off the planar light emitting devices near the read target in the 2-dimensional image sensor 1 is not required, and it is desired to be turned on, reversely and positively.

### Other Embodiments

As mentioned above, the present invention has been described by exemplifying the several embodiments. However, the present invention is not limited to only the above-mentioned embodiments, and other various additions and modifications can be made thereto. For example, the following variation is also included in the present invention.

In the above-mentioned respective embodiments, the reading operation of the skin pattern and blood vessel image between the fingertip and the second knuckle are targeted. However, since the large type of the 2-dimensional image sensor is used, this can be naturally applied to the readings of the skin pattern and blood vessel image of the different portion on the living body, such as the skin pattern and blood vessel pattern of a palm portion.

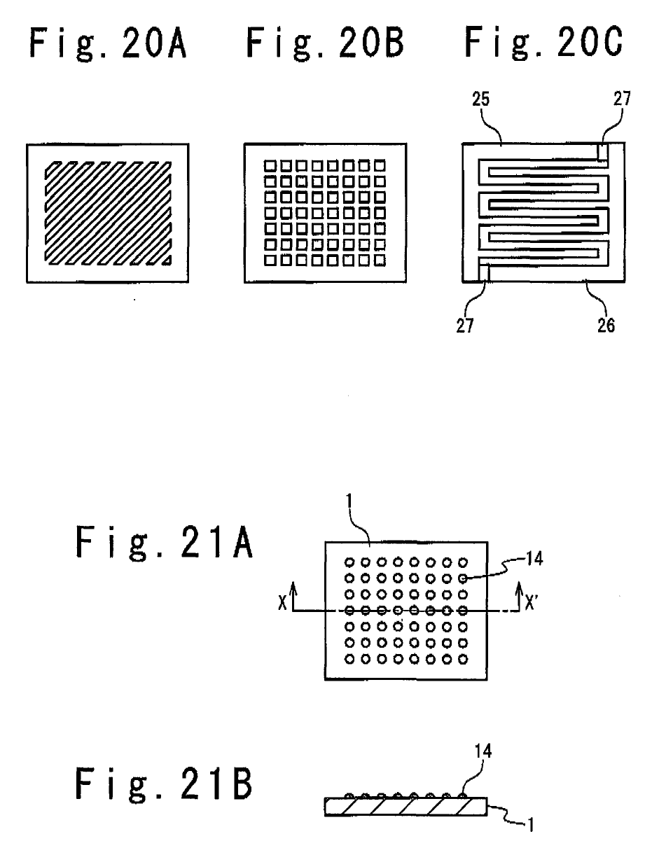

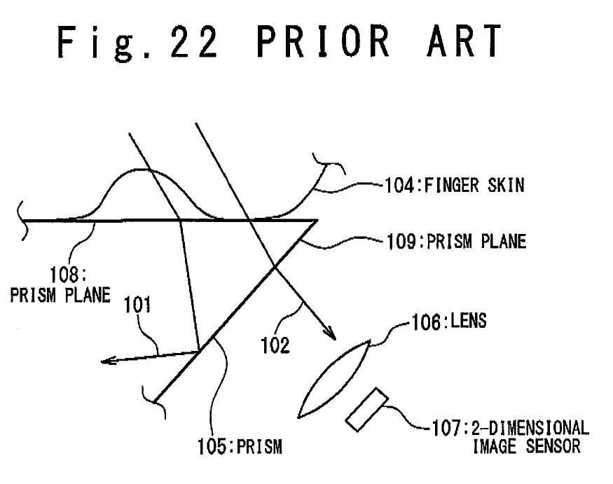

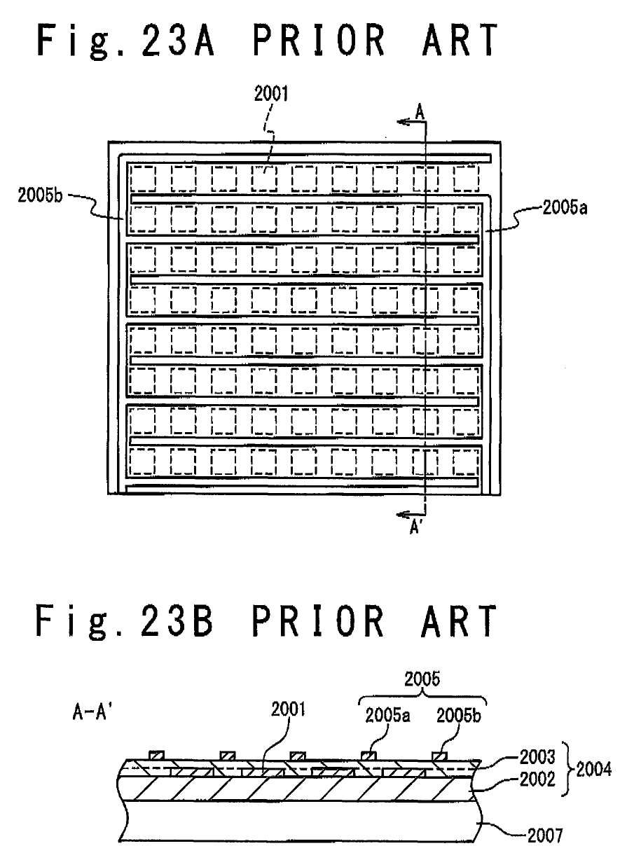

The array pattern of the partition walls, which perform the role as the guide so that the skin surface of the finger 7 is kept in a non-contact state in a constant distance from the top plane of the 2-dimensional image sensor 1 is not limited to the partition walls 22 formed in parallel on the lattice plate 20, as described in the embodiments. For example, the partition walls may be any pattern such as a pattern arranged in an oblique direction as shown in FIG. 20A, and a pattern arranged to intersect longitudinally and laterally, as shown in FIG. 20B. Also, as shown in FIG. 20C, the partition walls may be configured such that a pair of conductive lattice plates 25 and 26 in which comb teeth are alternately tangled are linked through an insulator 27, and at least one of the lattice plates 25 and 26 is grounded, resulting in discharging the static electricity charged on the finger and then detecting the contact of the finger.

Moreover, the partition walls, which perform the role as the guide so that the skin surface of the finger 7 is kept in the non-contact state in the constant distance from the top plane of the 2-dimensional image sensor 1, can be formed integrally with the 2-dimensional image sensor 1, other than the formation on the lattice plate 20 of a body different from the 2-dimensional image sensor 1, For example, the layer having a thickness between about several tens of micrometers and two hundred micrometers is formed on the sensor protection film of the top layer in the 2-dimensional image sensor 1, and this layer is processed, which can form the pattern corresponding to the partition wall 22 and the slit 21. Also, as shown in FIGS. 21A and 21B, a plurality of micro partition walls 14 may be formed on the sensor protection film of the 2-dimensional image sensor 1. In this case, the relation between the height H of the partition wall 14 and a distance W between the partition walls adjacent to each other corresponds to the relation between a height H of the partition wall 22 and a width W of the slit 21 in the fifth embodiment.

Also, in case that there are a large number of partition walls which perform the role as the guide so that the skin surface of the finger 7 is kept in the non-contact state in the constant distance from the top plane of the 2-dimensional image sensor 1 and in which the optically transmissible filler, which is different in the refractive index from the partition wall, is further inserted into the slit, there is a slight probability that a pattern caused by the partition walls, and the filler appears as noise in the read image. Accordingly, in order to remove this influence, when the standard detection sample serving as the replica of the finger, which has no fingerprint at all and has a smooth skin surface and has no blood vessel, namely, the standard detection sample in which the read target pattern and the read target blood vessel do not exist is read, the image of the 2-dimensional image sensor 1 is stored as a compensation image in the memory of the microprocessor 6. This compensation image includes a pattern caused by the partition walls and the filler. Then, when the compensation image is subtracted from the read images obtained when the finger 7 is actually read, the influence of the noise may be removed.

Also, since a skin pattern of the finger and the like can be read only through a natural light, the light source for the pattern can be omitted and only the light source for the blood vessel may be used.

As mentioned above, the image reading apparatus according to the present invention is useful for the reading apparatus that stably reads: the pattern of the fingerprint of the finger and the blood vessel image; and the blood figure and has the small scale and the low price. In particular, this is suitable for the apparatus that can input the living body feature even under the adverse conditions such as the wet or dry state of the finger, the skin separation caused by the dermatitis, and the like,

What is claimed is:

1. An image reading apparatus comprising:
first and second light sources configured to emit first and second lights into a detection target, respectively;
a 2-dimensional image sensor having light receiving elements arranged in a matrix, and configured to pick up a light emitted from said detection target through the emission of the first light from said first light source to generate a first image indicating a first pattern corresponding to an internal structure of said detection target, and to pick up a light emitted from said detection target through the emission of the second light from said second light source to generate a second image indicating a second pattern corresponding to a surface pattern of said detection target; and
a processing unit configured to drive said first and second light sources while switching said first and second light sources, and to perform a predetermined process on said first and second images.

2. The image reading apparatus according to claim 1, wherein at least one of a direction of the emission of the first light and the wavelength of the first light is set to be adaptive to generate said second image, and at least one of a direction of the emission of the second light and a wavelength of the second light is set to be adaptive to generate said first image.

3. The image reading apparatus according to claim 1, wherein said first light source emits the first light of a wavelength band in a near-infrared wavelength range corresponding to an absorption spectrum of hemoglobin.

4. The image reading apparatus according to claim 1, wherein said first light source and said second light source are provided on a rear side of said 2-dimensional image sensor.

5. The image reading apparatus according to claim 1, wherein said first light source and said second light source are provided on a lateral side of said 2-dimensional image sensor.

6. The image reading apparatus according to claim 1, wherein said first light source and said second light source are provided above of said 2-dimensional image sensor.

7. The image reading apparatus according to claim 1, further comprising:
a transparent solid film arranged on a top surface of said 2-dimensional image sensor and having a refractive index larger than 1.1 and smaller than 1.4 or larger than 2.0 and smaller than 5.0.

8. The image reading apparatus according to claim 1, further comprising:
partition walls as protrusions configured to keep said detection target in a non-contact state in a predetermined distance from a top surface of said 2-dimensional image sensor.

9. The image reading apparatus according to claim 8, wherein said partition walls form slits.

10. The image reading apparatus according to claim 8, wherein said partition walls have a light shielding property.

11. The image reading apparatus according to claim 8, wherein said partition walls have a light transmissible property.

12. The image reading apparatus according to claim 8, wherein said partition walls have a refractive index larger than 1.1 and smaller than 1.4 or larger than 2.0 and smaller than 5.0.

13. The image reading apparatus according to claim 9, wherein said slits are filled with fillers having a light transmissible property.

14. The image reading apparatus according to claim 13, wherein said fillers have a refractive index larger than 1.1 and smaller than 1.4 or larger than 2.0 and smaller than 5.0.

15. The image reading apparatus according to claim 9, wherein said slits are provided straightly on or above said light receiving elements of said 2-dimensional image sensor.

16. The image reading apparatus according to claim 8, wherein heights of said partition walls are in a range of 10 μm to 200 μm.

17. The image reading apparatus according to claim 1, wherein light emitting devices of said first light source and light emitting devices of said second light source are arranged in parallel to a direction of vertical scanning of said 2-dimensional image sensor on a rear side of said 2-dimensional image sensor, and said light emitting devices other than said light emitting devices near a read target line are turned on in synchronization with the vertical scanning of said 2-dimensional image sensor.

18. The image reading apparatus according to claim 1, wherein said processing unit stores a correction image of a reference detection target which has no first and second patterns, and subtracts said correction image from said first and second images read by said 2-dimensional image sensor.

19. The image reading apparatus according to claim 11, wherein said partition walls and said 2-dimensional image sensor are unified.

20. The image reading apparatus according to claim 11, wherein said partition walls are formed in a lattice plate located on or above the top surface of said 2-dimensional image sensor.

21. An image reading method comprising:
picking up by a 2-dimensional image sensor, light emitted from a surface of a detection target in a state that light is emitted from one of a first light source and a second light source into said detection target provided above said 2-dimensional image sensor which has a plurality of light receiving elements arranged in a matrix, to produce a first image;
picking up by said 2-dimensional image sensor, light emitted from the surface of said detection target in a state that light is emitted from the other of said first light source and said second light source, to produce a second image; and
calculating a difference between said first image and said second image.
